(19) United States
(12) Patent Application Publication
(10) Pub. No.: US 2004/0123253 A1
(43) Pub. Date: Jun. 24, 2004

(54) Sensitivity based pattern search algorithm for component layout

(76) Inventors: Chandandumar Aladahalli, Pittsburgh, PA (US); Jonathan Cagan, Pittsburgh, PA (US); Kenji Shimada, Pittsburgh, PA (US)

Correspondence Address: THORP REED & ARMSTRONG, LLP, ONE OXFORD CENTRE, 301 GRANT STREET, 14TH FLOOR, PITTSBURGH, PA, 15219-1425, US

(21) Appl. No.: 10/672,442

(22) Filed: Sep. 26, 2003

Related U.S. Application Data
(60) Provisional application No. 60/414,311, filed on Sep. 27, 2002.

(51) Int. Cl. G06F 17/00; G06N 5/02; G06F 17/50

(52) U.S. Cl. 716/2; 706/46

(57) ABSTRACT

A solution to determining the move set ordering in pattern searching is disclosed that involves driving a pattern search algorithm by a metric other than the step size of the patterns. An instance of this metric is the amount of change in an objective function. Preprocessing algorithms are disclosed which quantify the effect each move has on the objective function. Those moves having a greater effect on the objective function are applied before moves having a lesser effect. We call this effect on the object function the sensitivity of the object function to a particular move and present several methods to quantify it. The sensitivity may be expressed as a function or the moves can be ranked and clustered with the pattern search being driven by the ranked moves or the function.

This application claims priority from U.S. provisional patent application serial No. 60/414,311 filed Sep. 27, 2002 and entitled Sensitivity Based Pattern Search Algorithm for 3D Component Layout, the entirety of which is hereby incorporated by reference.

### BACKGROUND

The present disclosure is directed generally to pattern based search techniques which can be used, for example, for solving packing and component layout problems.

Many mechanical, electronic and electromechanical products are essentially a combination of functionally and geometrically inter-related components. The spatial location and orientation of these components affect a number of physical quantities of interest to the designer, engineer, manufacturer and the end user of the product. Some examples of these quantities are compactness, natural frequency, ease of assembly, routing costs, and accessibility. 3D component layout concerns itself with determining the optimal spatial location and orientation of a set of components given some objective function (i.e., means of measuring if one solution is better than another solution) and constraints. This objective function can include a quantification of a variety of measures such as the amount of cable used in the engine compartment of a car, or the packing density in an electric drill, or the center of gravity of a space vehicle. Constraints could include spatial relationships between components and between a component and the container. The variety of products and layouts that can be dealt within the 3D layout framework is large.

The 3D layout problem can be classified into the following four sub domains: simple 3D layout, 3D layout with optimization, 3D layout with special constraints and 3D layout with optimization and 3D special constraints.

The simple 3D layout problem just requires that there be no intersection between components and that there be no protrusion of components outside the container. This problem does not have very many practical applications but is the fundamental problem upon which the problems of the other sub domains are constructed.

The simple 3D layout problem is technically a constraint satisfaction problem defined as: find x₁, x₂, . . . ,xₙ such I(x₁, x₂, . . . ,xₙ)<ε where I(x₁, x₂, . . . ,xₙ) is the sum of the pair wise intersection between components and the protrusion of components outside the container. The arguments x₁, x₂, . . . ,xₙ represent the coordinates (x,y,z) of particular points on the different components along three independent axes and the orientations (θ₁,θ₂,θ₃) of the components about three independent axes. E is the user defined maximum tolerance on intersection and protrusion volumes. We allow a non-zero value for E because in tight packing situations it is difficult to find a layout with zero intersection and protrusion. It is easier to allow for a small amount of intersection and protrusion (usually less than 1%) of the total volume of components) and then remove it by post processing. The above constraint satisfaction problem is modeled as an unconstrained minimization problem as follows:

Minimize O(x₁, x₂, . . . ,xₙ)=I(x₁, x₂, . . . ,xₙ).

We hope that by minimizing I(x₁, x₂, . . . ,xₙ) we can make it less than ε and thus satisfy the constraint I(x₁, x₂, . . . ,xₙ)<_{ε}.

In 3D layout with optimization, apart from avoiding intersections and protrusions, a user defined objective function is required to be minimized. This problem has quite a few applications, examples being SLA container packing (while minimizing height) and center of gravity reduction for a vehicle.

This is a constrained optimization problem where we are required to minimize a user defined function C (x₁, x₂, . . . ,xₙ) subject to the same constraint as in simple 3D layout, i.e., minimize C (x₁, x₂, . . . ,xₙ) subject to I(x₁, x₂, . . . ,xₙ)<_{ε}.

Again we model this as an unconstrained minimization problem by including the constraint in the objective function as follows:

Minimize O(x₁, x₂, . . . ,xₙ)=I(x₁, x₂, . . . ,xₙ)+ωC(x₁, x₂, . . . ,xₙ), where ω is an appropriate weighing factor between the two objective function components.

It can be seen that the parameter ω is critical in solving this problem. An appropriate value for ω needs to be chosen so that the constraint I(x₁, x₂, . . . ,xₙ)<_{ε} is satisfied.

3D layout with 3D spatial constraints is a constraint satisfaction problem with additional user defined spatial constraints. This sub domain has a lot of practical applications. These include automobile engine compartment packing, layout of printed circuit board components, and packing in electromechanical devices such as printers and cameras.

Currently the 3D spatial constrains are modeled in the objective function itself as soft constraints, i.e., the constraint violations are penalized by adding their magnitude to the objective function. This may not be the best way to satisfy spatial constraints because the equality constraints may never be satisfied. 3D spatial constraint satisfaction is an active research area on its own and we do not speculate here on the appropriate mathematical model to solve it.

3D layout with optimization and 3D spatial constraints is a combination of the 3D layout with optimization and 3D layout with 3D spatial constraints. As mentioned above, 3D spatial constraint satisfaction is a very difficult problem and we do not speculate about it here.

Many different stochastic search algorithms have been applied to the 3D layout problem. These include genetic algorithms, simulated annealing and extended pattern search (EPS). Extended pattern search is basically pattern search with extensions to make it stochastic. Pattern search uses move sets (patterns) to explore the search space. In 3D component layout, these moves are typically translations and rotations of the components.

Pattern search methods are a subclass of direct search methods that utilize only direct comparisons of objective function values. Direct search methods are well suited for problems in which there is no gradient information available. A variety of direct search methods have been developed and used over the past fifty years. Torczon and Trosset (“From Evolutionary Operation to Parallel Direct Pattern Search: Pattern Search Algorithms for Numerical Optimization,” Computing Science and Statistics 29(1) pp. 396-401 (1997)) explicated the common structure and key features of the above search methods and defined a general framework called the Generalized Pattern Search method (GPS). Torczon also established a rigorous framework to mathematically deal with the above variety of direct search methods and proved their local convergence. Torczon and Trosset synthesized the various pattern search methods developed over the past fifty years into the common framework of the GPS algorithm. The complete set of definitions can be found in Torczon, “On the Convergence of Pattern Search Algorithms.” SIAM Journal of Optimization, 7(1), pp 1-25 (1997).

As the name implies, the General Pattern Search (GPS) algorithm uses the set of patterns Pₖ to explore the search space. For example moving 2 units along the x-direction and 1 unit along the y-direction is a possible pattern in 2D component layout. The magnitude of the steps is controlled by the step size control parameter.

In the initial stages of the search the step sizes are large so that the algorithm can reach any point in the search space. As the algorithm proceeds the step size is decreased until a threshold step size is reached after which the algorithm terminates. At a given step size, a trial move is attempted along a pattern direction. Any step that leads to a better state is accepted and a trial move is attempted again and so on. Only when all attempts to make a successful move at a step size have failed, is the step size reduced.

Pattern search developed mainly as a technique for numerical function minimization. Usually the function to be minimized consisted of only a few variables and was non-linear. Yin and Cagan (“An Extended Pattern Search Algorithm for Three-Dimensional Component Layout” ASME Journal of Mechanical Design, 122(1) pp 102-108 (2000)) first applied the pattern search algorithm to the 3D component layout problem. They introduced several modifications of the algorithm for 3D component layout, resulting in the Extended Pattern Search (EPS) algorithm discussed below. Those modifications include randomized search orders, step jumps, swap moves, and a hierarchical objective function model.

The EPS algorithm begins by taking as input a number of components, a container, an objective function, and constraints. Constraints describe the spatial relations between components and between components and the container. Two sets of pattern directions are used, namely the translation and the rotation pattern matrices. Each component could have a different set of move directions to accommodate the constraints on them. Pattern matrices are essentially chosen to reflect the permitted move directions for each component as well as any additional search strategy.

From an arbitrary initial state of the components, translation moves are first applied. Components are randomly selected and are translated, thus generating a new state. A new state is accepted if it results in an improvement in the objective function, else the original state is retained. This process is repeated for all components. If there is no improvement for any of the translations attempted, the step size for translations is scaled down by a factor less than, but close to 1. Next the rotation moves are applied. A component is picked at random and rotated. The same rules (as for the translation moves) for new state acceptance and step size updating apply here. If none of the translations and rotations results in an improved objective function, swap moves are applied. A swap move swaps the positions of two randomly picked components.

The translation and rotation moves repeat until the stopping criterion is met. The stopping criterion is whether both the translation and rotation step sizes are below a pre-specified tolerance.

The parameters related to pattern search are starting and ending step size, scheduling the various moves and the number of steps between the starting and ending step sizes. The performance of the algorithm depends on the above-mentioned parameters. By performance we mean the quality of the final solution and the time (number of iterations) required to reach it. These parameters occur in all the sub-domains where we use pattern search.

Apart from these for 3D layout with optimization sub-domain, the relative weighting between the two terms in the objective function, ω also needs to be decided. Additionally in sub domains where 3D spatial constraints are involved we will have more parameters to decide depending on the mathematical model and solution algorithm used.

### BRIEF SUMMARY OF THE DISCLOSURE

The present disclosure is directed to a method of performing a pattern based search characterized by driving the search with a metric other than step size. For example, the metric can be based on a change in value of an objective function or the sensitivity of the objection to component moves.

The present disclosure is also directed to a method comprised of determining the effect of a plurality of moves on a set of components and performing a pattern based search based on the determining. The determining may include ranking each of the plurality of moves based on the change each move has on an objective function and ordering the moves from highest to lowest ranking. The ranking can be performed analytically, probabilistically, or heuristically. The determining may additionally be comprise of dividing the range between highest and lowest rankings into a plurality of intervals and assigning each of the moves to one of the intervals. The assigning may be performed according to either a geometric progression based on the rankings or the rankings themselves.

In an alternative embodiment, the determining may include deriving a function that relates moves to changes in an objective function. The search may be driven by the function.

The present disclosure is also directed to preprocessing methods comprising ranking each of a plurality of moves on a set of components based on the effect each move has on an objective function and ordering the moves from those moves having the highest ranking to those moves having the lowest ranking.

The present disclosure is also directed to a preprocessing method comprised of deriving a function that relates moves to changes in an objective function.

The present disclosure is also directed to a preprocessing method comprising ranking each of a plurality of moves on a set of components based on the effect each move has on an objective function and clustering the moves into intervals based on the ranking.

The present disclosure is also directed to apparatus for performing the disclosed methods as well as storage devices carrying ordered sets of instructions which, when executed, performed the disclosed methods.

### BRIEF DESCRIPTION OF THE DRAWINGS

For the present invention to be easily understood and readily practiced, the present invention will now be described, for purposes of illustration and not limitation, in conjunction with the following figures, wherein:

FIG. 1 illustrates a method for evaluating sensitivity S in two dimensions;

FIG. 2 illustrates the sensitivity of the intersection volume on different moves and step sizes;

FIG. 3 illustrates a preprocessing algorithm;

FIG. 4 illustrates a preprocessing process;

FIG. 5 is a flow chart illustrating one embodiment of a sensitivity-based pattern search;

FIG. 6 is a flow chart illustrating another embodiment of a sensitivity-based pattern search;

FIGS. 7A, 7B and 7C illustrate three test cases; and

FIG. 8 illustrates hardware for implementing a sensitivity-based pattern search.

### DETAILED DESCRIPTION

In this disclosure we present a novel solution to determining the move set ordering in pattern searching. Preprocessing algorithms are disclosed which quantify the effect each move has on an objective function. Those moves having a greater effect are applied before moves that effect the objective function less. Therefore, the pattern search is driven by a metric other than step size. We call this effect on the object function the sensitivity of the object function to a particular move and present several methods to quantify it. Using our disclosed move set ordering, we were able to reduce run-time over traditional pattern searching by up to twenty-five (25%) percent or more.

The most common moves used in 3D component layout are translations and rotations. Starting from an initial configuration, components are translated and rotated until a good packing/layout is achieved. There are three independent axes along which a component can be translated and three independent axes along which it can be rotated. This means that for an unconstrained problem a minimum of six mutually independent patterns per component is required to completely explore the search space, assuming that there is sufficient resolution in the step sizes.

Previously in EPS, no attention was paid to the ordering of these six different moves for the different components. Translations and rotations were applied intermittently and were independent of each other. For each component, at a particular step size, all the translation moves for different components were tried out, and if all of them failed then the step size was reduced. Next, at a particular rotation step size rotation moves for different components were tried. If all of them failed, then the rotation step size was reduced. The translations and rotations started all over again at the new step size.

Observe, however, two characteristics of the EPS algorithm: First, it makes sense to avoid moves such as the rotation of spheres, because they do not affect an objective function like I(x₁, x₂, . . . ,xₙ), whereas rotation of objects like cubes does affect the objective function. Second, big step sizes are applied earlier followed by a smaller and smaller step sizes. This is because a move with a larger step size has more effect on the objective function I(x₁, x₂, . . . ,xₙ) than a move with a smaller step size. Putting the above two observations together we see that the scheduling of moves can be associated with the sensitivity of the objective function to the different moves. We also see that the sensitivity of the objective function not only depends on the move but also on the step size of the move. We therefore define sensitivity S of the objective function I(x₁, x₂, . . . , xₙ) to a move sᵢ^{k} as follows:

$$S = {\int }_{{V}^{′}} r ⅆ V \qquad ( 1 )$$

where V′ is the non-intersecting volume between an object and itself after applying the move sᵢ^{k} and r is the displacement of the infinitesimal volume dV. See FIG. 1 for an analogous 2D example.

From the above definition, the sensitivity associated with a move depends on both V′ and r, i.e., S depends on both the pattern and the step size. Because a pattern includes the object to which it is applied, S depends on the object and hence on its geometry. The above definition quantifies the displacement of an object due to the move. Also this displacement is useful only if it moves a volume element to a place not occupied by the object before the move. Therefore we integrate only over the non-intersecting volume. See FIG. 1. The rationale behind this quantification is that the more non-intersecting volume after a move, the bigger effect the move can have on the intersection and protrusion volume. Also the farther a non-intersecting volume element is displaced, the bigger the effect on the intersection and the protrusion volume. Therefore this definition is representative of the average effect of a move on the objective function I(x₁, x₂, . . . ,xₙ).

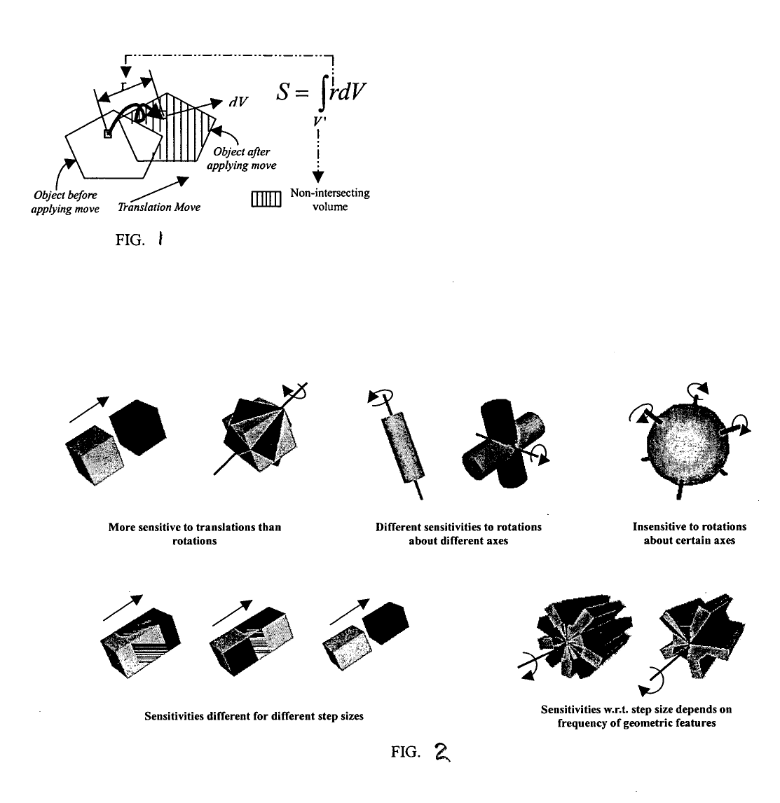

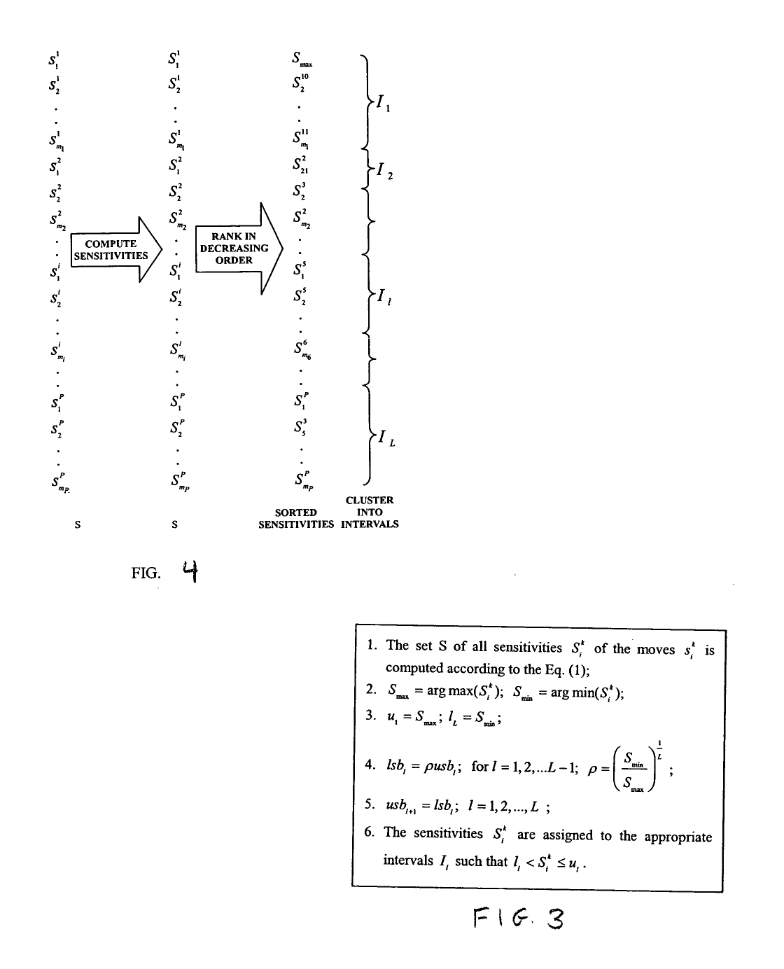

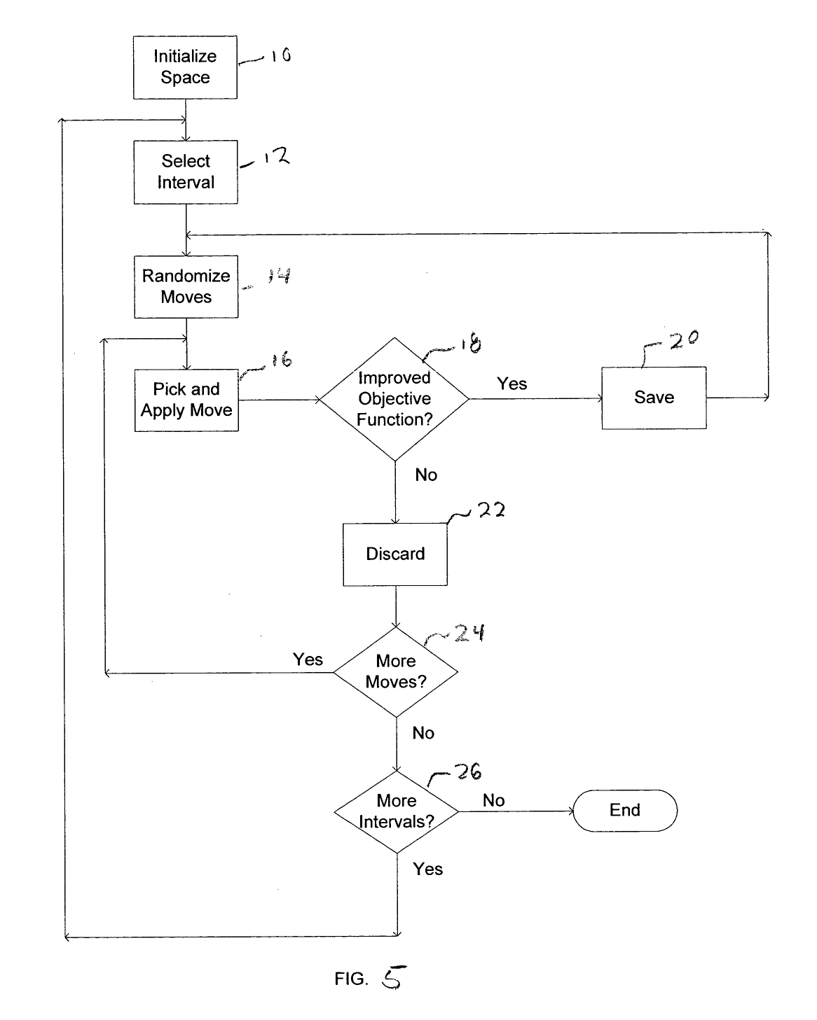

The integral is evaluated as a discrete sum over all the voxels of the object using its octree decomposition. A few examples of the dependence of sensitivity on the pattern and the step size are illustrated in FIG. 2.

We emphasize here that the above definition is not unique, but it serves the purpose of measuring how much a move might affect the objective function. Sensitivity could be derived analytically, probabilistically or heuristically. In a preferred embodiment, sensitivity would be computed in a statistical sense, i.e., conduct a large number of experiments with random placement of the components, apply the move whose sensitivity we are interested in computing and take an average of the change in the objective.

Though the particular definition above for sensitivity is developed with respect to the intersection and protrusion violation I(x₁, x₂, . . . ,xₙ), the sensitivity-based pattern search (SPS) algorithm based on it does better than the EPS algorithm even for more general objective functions involving additional objectives to optimize. Also, though the above definition is specific to the 3D layout situation, we believe the concept of sensitivity is also applicable to other optimization problems. The difference will be the way in which the sensitivity of the objective function is quantified.

As previously mentioned, our disclosure aspires for bigger improvements first and smaller improvements towards the end. Efficient means that the algorithm with the new order will either give a lower objective function value for the same number of iterations or will take fewer iterations to converge to a similar objective function value as the existing EPS algorithm.

The patterns that are used during the course of the search are denoted by the columns of a matrix Pₖ, see Aladahalli, C., Cagan, J., Shimada, K., “A Sensitivity-based Pattern Search Algorithm for 3D Component Layout”, Proceedings of the ASME DETC 2001, Montreal Canada (2001). In the new SPS algorithm, the set of patterns is fixed and there is no concept of updating the pattern matrix. Hence we drop the subscript k from the matrices. Therefore

P=BC=[BM−BM BL]=[BΓ BL]. (2)

The matrices B and c are required to satisfy conditions placed on them in the original pattern search method.

Δᵢ¹ and Δᵢ^{m}^{ᵢ} denote the first and last step size of the ih pattern respectively. As mentioned before a pattern includes the direction of move and the component to which it is applied. Note that the i^{th} pattern takes mᵢ possible step sizes.

A move is defined as the product of the k^{th} step size of the i^{th} pattern Δᵢ¹, and the i^{th} pattern P.

sᵢ^{k}Δᵢ^{k}Pᵢ, k=1, 2, . . . ,mᵢ. (3)

Here mᵢ is the total number of step sizes for the i^{th} pattern. So the total number of moves M is given by

$$M = {\sum }_{i = 1}^{i = P} {m}_{i} ,$$

where P is the total number of patterns in the pattern matrix. Sᵢ^{k}, denotes the sensitivity of the objective function to the move sᵢ^{k}.

A sensitivity interval I, ε (□,□) is defined as

I₁=(usb₁, lsb₁), l=1,2, . . . ,L.

Here usb₁ and lsb₁ are the upper and lower sensitivity bounds of the interval. As we shall see later the interval I₁ contains the moves whose sensitivity lies in the interval defined by (usb₁, lsb₁). L is the total number of intervals.

The SPS algorithm is divided into two parts: preprocessing and search. The preprocessing part basically involves, in one embodiment, calculating sensitivities of each move, ranking them in a decreasing order and grouping them into intervals. The search part does the actual search.

Because the SPS algorithm uses sensitivities to rank the moves, it first calculates the sensitivities of the moves according to Eq. (1) (Step 1 in FIG. 3). From these sensitivities the maximum and minimum values are picked (Step 2 in FIG. 3). The range defined by the maximum and minimum sensitivities is divided into intervals (Steps 3, 4 and 5 in FIG. 3). The basic idea is to cluster the different moves with similar sensitivities into intervals. Currently we simply divide the range between the maximum and minimum sensitivity into intervals geometrically, i.e., lsbᵢ=usbᵢ₊₁

$$\frac{{lsb}_{i}}{{usb}_{i}} = ρ ,$$

where ρ is a fixed scaling factor that depends on the number of intervals, L (see Step 4 in FIG. 3). Moves are then assigned to appropriate intervals, i.e., the sensitivity value of a move lies between the upper and lower sensitivity values of the interval to which it belongs (Step 6 in FIG. 3). The above method is not necessarily the best way to cluster the different moves, but is effective for this disclosure. Once the moves are thus classified the search begins. FIG. 3 gives an overview of the preprocessing algorithm, showing how sensitivities of moves are calculated, sorted, and then clustered.

Turning now to FIG. 5, the search portion of the SPS algorithm is illustrated. At 10, the space is initialized. At 12, an interval is selected. Thereafter, at 14, the moves are randomized and, at 16, one of the moves is picked and applied. A determination is made at 18 if the move has improved the objective function. If the answer is affirmative, the new layout is saved at 20 and process flow returns to 14. However, if the determination at 18 is that the objective function has not been improved, the new layout is discarded at 22 and a determination is made at 24 if there are more moves to be made. If that determination is answered in the affirmative, process flow returns to 16. If that determination is answered in the negative, another determination at 26 determines whether there are more intervals. If yes, process flow returns to 12 and, if not, the process ends.

Because the first interval contains moves with the highest sensitivity values, and the sensitivities progressively decrease as successive intervals are used, the moves are applied in decreasing order of their sensitivities.

FIG. 5 describes one round of the algorithm. As done with stochastic algorithms, the search may be restarted several times, and the best solution from among the searches may be chosen.

In GPS, at every step size, there are patterns corresponding to all the dimensions of the search space, i.e., at every step size the pattern matrix allows the algorithm to perturb the search space along all possible dimensions. Therefore the step size can be decreased only when after perturbing all the dimensions of the search space, an improved objective function has not been found. This is not guaranteed or required in the new SPS algorithm. An interval may not consist of moves corresponding to all possible search dimensions. For example, in a problem where there are very big objects and very small objects, the early intervals will generally not contain moves corresponding to the very small objects because the sensitivity of such moves is comparatively very small. Hence when the moves from the first interval are applied, the small objects are not perturbed. Even with the same object, such as a cube, big translation moves have higher sensitivity than rotational moves. Therefore the early intervals will not have moves corresponding to the rotation of the cube.

Also GPS employs a single step size control parameter for all the patterns, whereas SPS allows the use of different step size control parameters for each pattern. Therefore in SPS we can have different numbers of steps for each pattern.

Because in GPS all the search dimensions are active at any time during the search it can be shown that it has the property of local convergence. The SPS algorithm however, does not require that all search dimensions be active at any time in the search, and hence does not have the property of local convergence. This can be fixed by including a final interval that consists of moves with the smallest step size of all the patterns.

In the comparison of the GPS algorithm with the new SPS algorithm above, it is seen that pattern search has always been driven by step size, i.e. start with large step size and decrease the step sizes as you proceed with your search. Although the decrease need not always be uniform, step size is the metric which drives the search. In the new SPS algorithm, the search is driven by a metallic other than step size, i.e. a sensitivity metric. In the new SPS algorithm, the pattern search is begun with the largest sensitivity metric and decreases this metric as the search proceeds.

To implement the SPS algorithm, a number of parameters must be decided on. The important ones are discussed below. Each is used to tune the performance of the algorithm. In the current implementation these parameters were chosen for the purpose of comparison with the EPS algorithm.

The number and nature of the patterns P: This is obviously problem dependent and therefore there is no general rule. In the current implementation we use 2n patterns, i.e., P=BC=[BM−BM]. Both B and M are identity matrices in our implementation, i.e., each pattern perturbs exactly one variable in the objective function.

The total number of moves

$$M = {\sum }_{i = 1}^{i = P} {m}_{i} \text{:}$$

It is obvious that this depends on the number of step sizes for each pattern. In our current implementation all the mᵢ's are equal.

The number of intervals L: Currently we choose L such that we get a solution (objective function value) similar to the EPS algorithm solution. This selection of L allows for comparison with the EPS algorithm.

The different usbᵢ's and lsbᵢ's: As mentioned above we geometrically divide the sensitivity range to decide the usbᵢ's and lsbᵢ's. Again we use the geometric decrease only as a starting point. Also, because both GPS and EPS decrease the step size geometrically, we decided to do the same in our new algorithm to allow for comparison.

Definition of sensitivity: The definition of sensitivity according to Eq. (1) is appropriate for the current situation where the objective function is limited to the intersection and protrusion volume component I(x₁, x₂, . . . , xₙ).

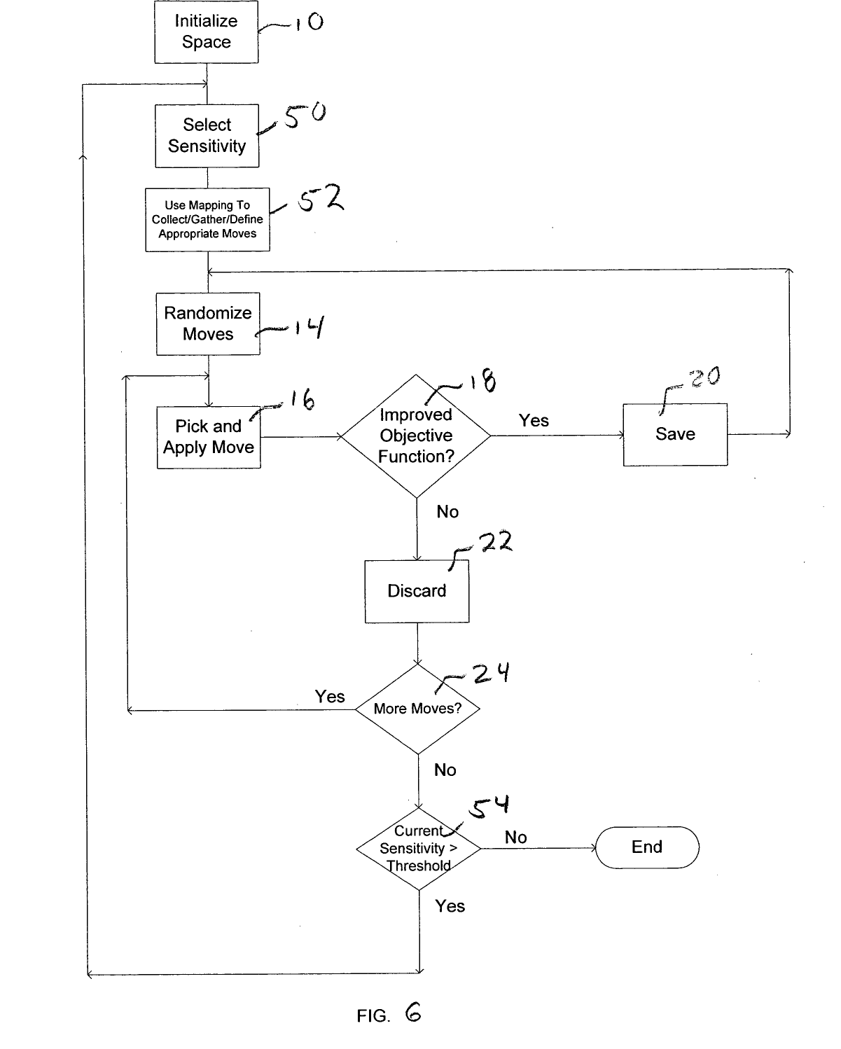

According to another embodiment illustrated in FIG. 6, a different type of preprocessing is performed. In this embodiment, preprocessing is performed so as to derive a function that relates move changes to sensitivities. This function is again derived from the sensitivity as defined in Equation 1. That function is then used to drive the search. For example, if the objective function varies between −1000 and +1000 and does so randomly, the maximum change in objective function value that can be attained is 2000 (1000−(−1000)). The minimum is, of course, 0. The SPS algorithm performs a pattern-based search based on this change in objective function. Thus, the pattern search starts with a parameter such as change_in_objective_function_value equal 2000 and constructs moves for patterns that can give this change. We construct moves corresponding to this value of change_in_objective_function by picking appropriate step-sizes for the patterns. Of course, some patterns may not be able to give a step size which corresponds to a change of 2000 and hence won't be included in a set of moves. Once these moves no longer improve the objective, we choose a smaller change_in_objective_function_value and repeat the process. We keep repeating the process until the change_in_objective_function_value desired falls below a threshold. Thus, the pattern search is now being driven by something other than step-size. This technique is shown in FIG. 6.

In FIG. 6, sensitivity is selected at 50. The selected sensitivity is used to either collect, gather, or define appropriate moves at 52 depending upon the function that has been derived. Thereafter, the process is substantially the same as shown in FIG. 5 except, at the end, instead of determining if there are more intervals, a determination is made at 54 as to whether the current sensitivity is greater than the threshold. If that determination is answered affirmatively, process flow continues with 50. If the sensitivity is below the threshold, the process ends.

Experiments and Results

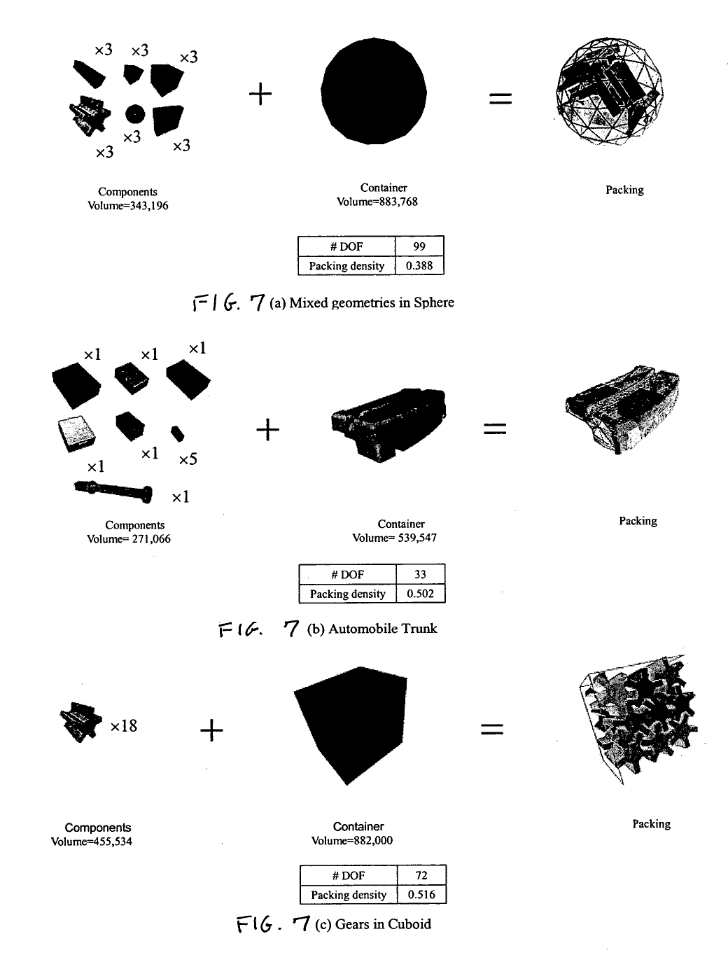

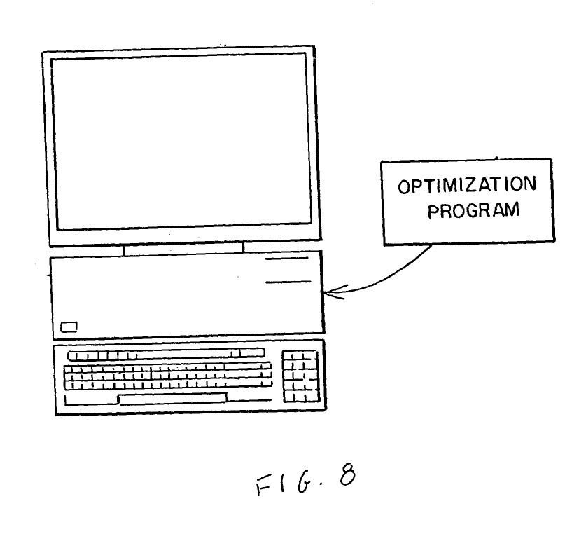

The SPS algorithm was tested on a set of layout problems. In the following examples swap moves were not used. This is not a limitation of the new algorithm, but our current interest was to compare the core pattern search algorithms. Also for the current test the objective function consisted of only I(x₁, x₂, . . . ,xₙ). The examples presented below are solvable in the sense that the final intersection and protrusion volume is less than some specified tolerance (1% of volume of components in the examples presented here). The set of test problems is described briefly below. The actual geometries and volume details are shown in FIG. 7

Example 1: Packing three big cubes, three small cubes, three rods, three plates, three gears, and three small spheres into a large sphere.

Example 2: Packing standard (SAE) luggage pieces into the trunk of a car.

Example 3: Eighteen gears packed into a cubic container. The container is sized such that the gears can all fit into the container only if their teeth intermesh.

All the three examples were tested 25 times with both the previous algorithm (EPS) and the new algorithm (SPS). Each test included three runs of the respective algorithm and the best of the three solutions was chosen. Each run started from a random initial configuration. I(x₁, x₂, . . . ,xₙ) was evaluated at the sixth level of octree resolution. The number of steps per pattern was 100, i.e., mᵢ=100 for all i.

The averages of the 25 runs are presented in Table 1. From the table, it can be seen that the SPS algorithm required fewer iterations to reach a similar objective function value in all the three examples. The time taken for the preprocessing is negligible (about 1%) compared to the time taken by the search algorithm in SPS.

TABLE 1

| | EPS | | SPS | | $\frac{EPS - SPS}{EPS} \times 100$ | |
|---|---|---|---|---|---|---|
| | Obj. Fn.* | | Obj.Fn.* | | | |
| | (%)^{$} | #Iterations | (%)^{$} | #Iterations | Obj. Fn. | #Iterations |
| Example 1 | 1058 | 28447 | 1052 | 22758 | 0.56% | 20.0% |
| (Sphere) | (0.31%) | | (0.30%) | | | |
| Example 2 | 1769 | 6677 | 1753 | 4766 | 0.89% | 28.6% |
| (Auto Trunk) | (0.65%) | | (0.64%) | | | |
| Example 3 | 1750 | 17105 | 1691 | 14450 | 3.37% | 15.5% |
| (Gears) | (0.39%) | | (0.38%) | | | |

*Objective function is the sum of intersection and protrusion volumes
^{$}Objective function as percentage of volume of components in the packing

The present disclosure introduces a new algorithm, Sensitivity-based Pattern Search (SPS) for 3D layout. This algorithm, though based on the Generalized Pattern Search algorithm accounts for the fact that different moves affect the objective function by different amounts and therefore classifies the moves in decreasing order of their effect on the objective function and applies them in that order. This effect is called the sensitivity.

In our preferred embodiment, the methods disclosed herein our embodied in software, stored on any appropriate type of storage medium, and implemented on a computer, as shown in FIG. 8. The computer, as configured by software for performing the methods of the present disclosure, forms an apparatus for performing the methods of the present disclosure.

While the present invention has been described in connection with preferred embodiments thereof, those of ordinary skill in the art will recognize that many modifications and variations are possible. The present invention is intended to be limited only by the following claims and not by the foregoing description.

What is claimed is:

1. A method of performing a pattern based search, characterized by driving the search with a metric other than step size.

2. The method of claim 1 wherein the metric for driving the search is based on a change in value of an objective function.

3. The method of claim 1 wherein the metric for driving the search is a sensitivity of an objective function to component moves.

4. A method, comprising:
determining the effect of a plurality of moves on a set of components; and
performing a pattern based search based on said determining.

5. The method of claim 4 wherein said determining includes ranking each of said plurality of moves based on the change each move has on an objective function and ordering said moves from highest to lowest ranking.

6. The method of claim 5 wherein said ranking includes one of analytically, probabilistically and heuristically ranking.

7. The method of claim 5 wherein said determining additionally comprises dividing the range between highest and lowest rankings into a plurality of intervals, and assigning each of the moves to one of said intervals.

8. The method of claim 7 wherein said assigning is performed according one of a geometric progression based on said rankings and said rankings.

9. The method of claim 4 wherein said determining includes deriving a function that relates moves to changes in an objective function.

10. The method of claim 4 wherein said determining includes determining the non-intersecting volume between an object and itself after applying a move.

11. A method, comprising:
ranking each of a plurality of moves on a set of components based on the effect each move has on an objective function; and
ordering the moves from those moves having the highest ranking to those moves having the lowest ranking.

12. The method of claim 11 wherein said ranking includes one of analytically, probabilistically and heuristically ranking.

13. The method of claim 11 additionally comprising dividing the range between the maximum and minimum rankings into a plurality of intervals, and assigning each of the moves to one of said intervals.

14. The method of claim 13 wherein said assigning is performed according to one of a geometric progression based on said rankings and said rankings.

15. The method of claim 11 wherein said ranking includes determining the non-intersecting volume between an object and itself after applying a move.

16. A method, comprising:
ranking each of a plurality of moves on a set of components based on the effect each move has on an objective function; and
clustering said moves into intervals based on said ranking.

17. The method of claim 16 wherein said ranking includes one of analytically, probabilistically and heuristically ranking.

18. The method of claim 16 wherein said clustering includes dividing the range between the maximum and minimum rankings into a plurality of intervals, and assigning each of the moves to one of said intervals.

19. The method of claim 18 wherein said assigning is performed according to one of a geometric progression based on said rankings and said rankings.

20. The method of claim 16 wherein said ranking includes determining the non-intersecting volume between an object and itself after applying a move.

21. A preprocessing method, comprising:
deriving a function that relates moves to changes in an objective function.

22. The method of claim 21 wherein said deriving includes one of analytically, probabilistically and heuristically deriving.

23. A storage device carrying an ordered set of instructions which, when executed, performs a pattern-based search, characterized by driving the search with a metric other than step size.

24. The device of claim 23 wherein the metric for driving the search is based on a change in value of an objective function.

25. The device of claim 23 wherein the metric for driving the search is a sensitivity of an objective function to component moves.

26. A storage device carrying an ordered set of instructions which, when executed, perform a method comprising:
determining the effect of a plurality of moves on a set of components; and
performing a pattern based search based on said determining.

27. The device of claim 26 wherein said determining includes ranking each of said plurality of moves based on the change each move has on an objective function and ordering said moves from highest to lowest ranking.

28. The device of claim 27 wherein said ranking includes one of analytically, probabilistically and heuristically ranking.

29. The device of claim 27 wherein said determining additionally comprises dividing the range between highest and lowest rankings into a plurality of intervals, and assigning each of the moves to one of said intervals.

30. The device of claim 29 wherein said assigning is performed according one of a geometric progression based on said rankings and said rankings.

31. The device of claim 26 wherein said determining includes deriving a function that relates moves to changes in an objective function.

32. The device of claim 26 wherein said determining includes determining the non-intersecting volume between an object and itself after applying a move.

33. A storage device carrying an ordered set of instructions which, when executed, perform a method comprising:
ranking each of a plurality of moves on a set of components based on the effect each move has on an objective function; and
ordering the moves from those moves having the highest ranking to those moves having the lowest ranking.

34. The device of claim 33 wherein said ranking includes one of analytically, probabilistically and heuristically ranking.

35. The device of claim 33 additionally comprising dividing the range between the maximum and minimum rankings into a plurality of intervals, and assigning each of the moves to one of said intervals.

36. The device of claim 33 wherein said assigning is performed according to one of a geometric progression based on said rankings and said rankings.

37. The device of claim 33 wherein said ranking includes determining the non-intersecting volume between an object and itself after applying a move.

38. A storage device carrying an ordered set of instructions which, when executed, perform a method comprising:
ranking each of a plurality of moves on a set of components based on the effect each move has on an objective function; and
clustering said moves into intervals based on said ranking.

39. The device of claim 38 wherein said ranking includes one of analytically, probabilistically and heuristically ranking.

40. The device of claim 38 wherein said clustering includes dividing the range between the maximum and minimum rankings into a plurality of intervals, and assigning each of the moves to one of said intervals.

41. The device of claim 40 wherein said assigning is performed according to one of a geometric progression based on said rankings and said rankings.

42. The device of claim 38 wherein said ranking includes determining the non-intersecting volume between an object and itself after applying a move.

43. A storage device carrying an ordered set of instructions which, when executed, perform a preprocessing method comprising:
deriving a function that relates moves to changes in an objective function.

44. The method of claim 43 wherein said deriving includes one of analytically, probabilistically and heuristically deriving.
